(19) United States
(12) Patent Application Publication
(10) Pub. No.: US 2025/0239049 A1
(43) Pub. Date: Jul. 24, 2025

(54) INFORMATION PROCESSING APPARATUS, METHOD OF CONTROLLING INFORMATION PROCESSING APPARATUS, AND STORAGE MEDIUM

(71) Applicant: CANON KABUSHIKI KAISHA, Tokyo (JP)

(72) Inventor: KASHU MATSUMOTO, Kanagawa (JP)

(21) Appl. No.: 19/029,136

(22) Filed: Jan. 17, 2025

(30) Foreign Application Priority Data
Jan. 22, 2024 (JP) 2024-007266

(51) Int. Cl. G06V 10/762; G06N 3/08; G06V 10/60; G06V 10/74; G06V 10/764

(52) U.S. Cl. CPC G06V 10/762; G06N 3/08; G06V 10/60; G06V 10/761; G06V 10/764

(57) ABSTRACT

An apparatus includes a classification to classify a training data set for training a model into one of a plurality of clusters by clustering the set, a determination to determine image data in which a difference between a ground truth of the set and an inference result of training data by the model or verification data different from data used at a time of training is a threshold value or more, a calculation to identify a cluster to which the image data determined belongs, from among the plurality of clusters, and calculate a similarity between data classified into the identified cluster and the determined image data, and a selection to select, as training data for additionally training the model for an image quality improvement task, data from among data classified into the identified cluster where the similarity of the data calculated by the calculation is greater than a predetermined value.

### BACKGROUND

### Field

The present disclosure particularly relates to an information processing apparatus, a method of controlling the information processing apparatus, and a program, which are suitable for use in selecting training data.

### Description of the Related Art

In recent years, various services utilizing artificial intelligence (AI) have been provided, and a method using machine learning is known as a method of constructing a model for achieving AI that predicts any event. As one of algorithms of a machine learning model, supervised learning using training data including an input and a ground truth label is known.

When a model is constructed by using supervised learning, overlearning can be suppressed and prediction accuracy can be improved by training using high-quality training data. Herein, the high-quality training data represents training data that is highly effective in improving the prediction accuracy of the model. In addition, in order to tune to a model adapted to a specific state or use, it is necessary to train by using training data in which the state or use is considered. Consequently, it is important to appropriately select training data to be used in supervised learning.

Therefore, a method of excluding unintended data from training data has been proposed. Japanese Patent Application Laid-Open No. 2022-150552 discusses a technique in which clustering is performed in advance, based on a feature amount and class information of an object image in image data, and a cluster including erroneous class information is identified by using an average/variance of distances between a plurality of centroids in the cluster and the feature amounts.

When the machine learning model evaluates a plurality of evaluation indices, an evaluation score of a certain value or more may be required for each of the plurality of evaluation indices. When the evaluation score is low for a specific evaluation index, the evaluation score needs to be improved. For example, when training data is biased, training efficiently progresses for specific data, but training does not efficiently progress for other data, and the evaluation score remains low.

According to the method discussed in Japanese Patent Application Laid-Open No. 2022-150552, it is possible to appropriately select training data and efficiently perform training by excluding unintended data from the training data. However, it takes a very long time to search for erroneously clustered data from all classes. In addition, since only information within a cluster can be used, training efficiency of a neural network model for specific data cannot be sufficiently improved.

### SUMMARY

The present disclosure, which has been made in consideration of the above disadvantages, is directed to enabling efficient selection of training data, improve non-uniformity in training efficiency due to the training data, and improve the accuracy of a neural network model.

According to an aspect of the present disclosure, an information processing apparatus includes a classification unit configured to classify a training data set for training a neural network model into any one of a plurality of clusters by clustering the training data set, a determination unit configured to determine image data in which a difference between a ground truth of the training data set and an inference result of training data by the neural network model or verification data different from data used at a time of training is a threshold value or more, a calculation unit configured to identify a cluster to which the image data determined by the determination unit belongs, from among the plurality of clusters, and calculate a similarity between data classified into the identified cluster by the classification unit and the determined image data, and a selection unit configured to select, as training data for training the neural network model, data the similarity of which calculated by the calculation unit is a predetermined value or more, from among data classified into the identified cluster.

Further features of the present disclosure will become apparent from the following description of exemplary embodiments with reference to the attached drawings.

### BRIEF DESCRIPTION OF THE DRAWINGS

FIG. 1 is a block diagram illustrating a functional configuration example of an information processing apparatus according to an exemplary embodiment.

FIG. 2 is a flowchart illustrating an example of a processing procedure for selecting training data in the exemplary embodiment.

FIG. 3 is a diagram illustrating a method of generating a classifier using self-supervised learning.

FIG. 4 is a diagram illustrating a method of classifying a training data set.

FIGS. 5A and 5B are diagrams each illustrating a clustering method of difficult image data and a method of calculating similarity.

FIG. 6 is a diagram illustrating a method of generating a classifier using supervised learning.

FIG. 7 is a block diagram illustrating an example of a hardware configuration of the information processing apparatus according to the exemplary embodiment.

### DESCRIPTION OF THE EMBODIMENTS

Exemplary embodiments of the present disclosure will be described below with reference to the drawings. Note that the following exemplary embodiments do not limit the disclosure according to the claimed disclosure. Although a plurality of features is described in the exemplary embodiments, all of the plurality of features are not necessarily essential to the disclosure, and the plurality of features may be arbitrarily combined. Further, in the accompanying drawings, the same or similar components are denoted by the same reference numerals, and redundant description thereof will be omitted.

In the first exemplary embodiment, a flow of processing when a neural network model (hereinafter, referred to as an NN model) is trained will be described using a noise reduction task as an example. The noise reduction task is a task of estimating a noiseless image (pre-deterioration image) before deterioration due to noise from a noisy image (deterioration image) deteriorated due to noise.

A case where a plurality of evaluation indices is evaluated by using the NN model will be considered. For example, when an evaluation index (peak signal to noise ratio (PSNR)) regarding a less deterioration of an image is evaluated in a noise reduction task, the PSNR of each of a plurality of regions in the image may be evaluated. In addition, as a case where a plurality of evaluation indices is evaluated, a case where an accuracy for each class is evaluated in an object detection task is included. As described above, when the machine learning model evaluates a plurality of evaluation indices, an evaluation score of a certain value or more may be required for each of the plurality of evaluation indices. When the evaluation score is low for a specific evaluation index, the evaluation score needs to be improved.

A difference in the training efficiency of the NN models is considered as one of causes of the evaluation score being lower in a specific evaluation index. For example, when training data is biased, training progresses efficiently for specific data, a difference from a ground truth (GT) is small, and accuracy also increases. On the other hand, training does not progress efficiently for other data, the difference from GT is large, and the accuracy remains low.

In addition, in order to improve the evaluation score with an evaluation index with a low evaluation score, it is also considered to perform replacement or the like of a training data set, but it takes a long time to optimize the training data set or the like in order to improve the evaluation score of a specific evaluation index. Therefore, in the present exemplary embodiment, the training data set is clustered in advance and classified into a plurality of clusters, and added to the training data in accordance with a similarity from the cluster to which the data with a large difference from the GT belongs, whereby the training data can be selected more efficiently. Detailed processing in the present exemplary embodiment will be described below.

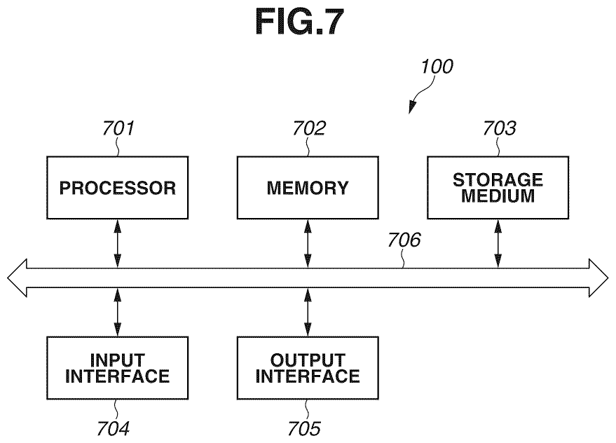

FIG. 7 is a block diagram illustrating an example of a hardware configuration of an information processing apparatus 100 according to the present exemplary embodiment.

In FIG. 7, a processor 701 is, for example, a central processing unit (CPU), and controls the overall operation of the information processing apparatus 100. A memory 702 is, for example, a random access memory (RAM), and temporarily stores a program, data, and the like. A computer-readable storage medium 703 is, for example, a hard disk, a compact disc read only memory (CD-ROM), or the like, and stores a program, data, and the like for a long term. In the present exemplary embodiment, a program that is stored in the storage medium 703 and that achieves a function of each unit is read into the memory 702. Then, the processor 701 operates in accordance with the program on the memory 702, thereby achieving the function of each unit.

In FIG. 7, an input interface 704 is an interface for acquiring information from a device of each unit. An output interface 705 is an interface for outputting information to an external device. A bus 706 connects the units at the top and enables data exchange.

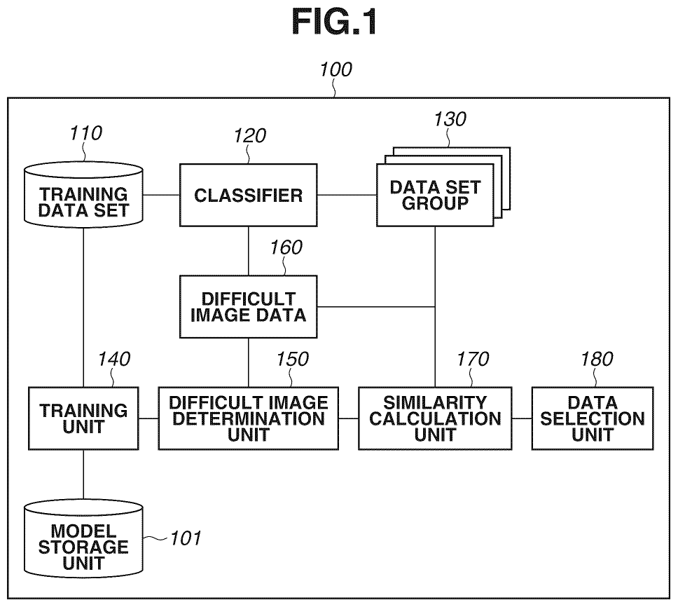

FIG. 1 is a block diagram illustrating an example of a functional configuration of the information processing apparatus 100 according to the present exemplary embodiment.

The information processing apparatus 100 includes a model storage unit 101, a training data set 110, a classifier 120, a data set group 130, a training unit 140, a difficult image determination unit 150, difficult image data 160, a similarity calculation unit 170, and a data selection unit 180.

The model storage unit 101 stores an NN model for the purpose of noise reduction. Although it is assumed that the NN model is trained in advance, the NN model is not limited to being trained in advance, and a trained NN model published by a third party may be used. As the NN model, a convolutional neural network (CNN) model having a convolutional layer may be used, or a transformer model having an attention mechanism may be used.

The training data set 110 is the same data set as the data set used for training the NN model stored in the model storage unit 101. Note that another image data set may be used as the training data set 110. The classifier 120 is a classifier generated for clustering the training data set 110 and the difficult image data 160 to be described below. The data set group 130 represents a result acquired by clustering the training data set 110 using the classifier 120. The training unit 140 trains the NN model stored in the model storage unit 101 by using the training data set 110.

The difficult image determination unit 150 determines the difficult image data, based on a difference between a result of the training data inferred by the training unit 140 and a GT of the training data set 110. Specifically, the difficult image determination unit 150 calculates the difference between the result of the training data inferred by the training unit 140 and the GT, and defines the training data as the difficult image data when the difference is a threshold value or more. The difficult image data 160 is image data determined to be difficult image data by the difficult image determination unit 150.

The similarity calculation unit 170 determines the cluster to which the difficult image data 160 belongs, and calculates a similarity with data of the data set group 130 existing in the same cluster. The data selection unit 180 selects data for additionally training the NN model from the data of the data set group 130 in the same cluster, based on the similarity acquired by the similarity calculation unit 170.

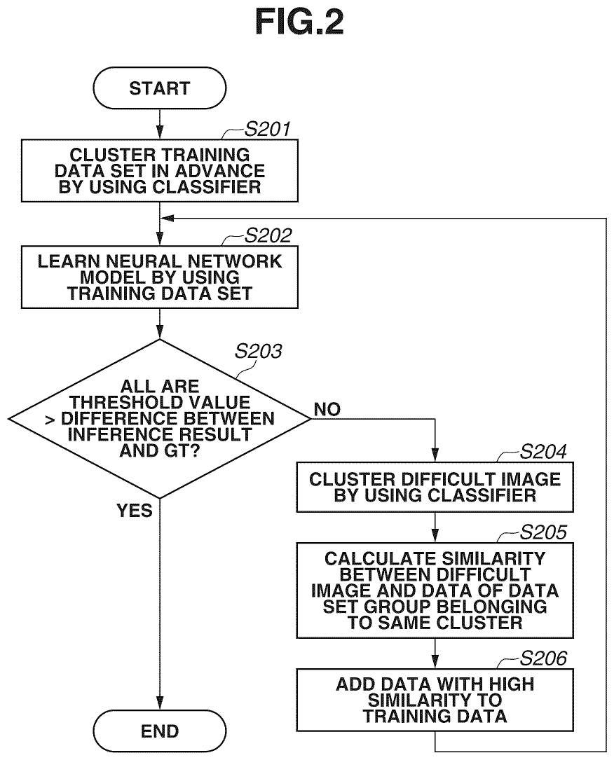

FIG. 2 is a flowchart illustrating an example of a processing procedure for selecting training data in the present exemplary embodiment.

In step S201, the processor 701 clusters the training data set 110 in advance by using the classifier 120. Hereinafter, a clustering method will be described in detail.

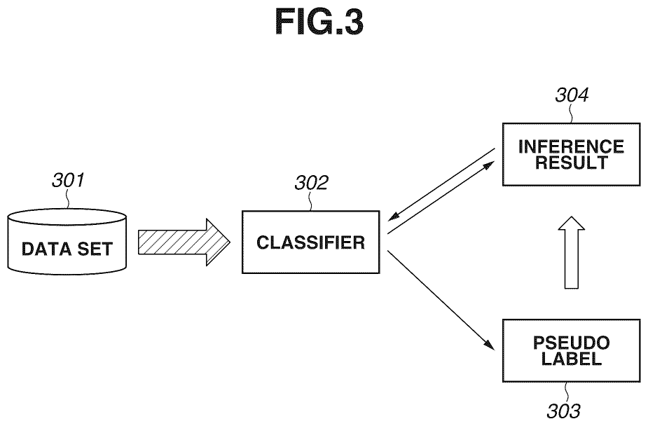

FIG. 3 is a diagram illustrating a method of generating a classifier using self-supervised learning according to the present exemplary embodiment. In the present exemplary embodiment, a classifier is generated by self-supervised learning called DeepCluster described in Mathilde Caron, Piotr Bojanowski, Armand Joulin, and Matthijs Douse: Deep Clustering for Unsupervised Learning of Visual Features. First, a data set 301 is input to a classifier 302, and the classifier 302 is trained by using a pseudo label 303 and an inference result 304. A training model used in the classifier 302 is not particularly limited, and for example, AlexNet described in Krizhevsky, A., Sutskever, I., Hinton, G. E: Imagenet classification with deep convolutional neural networks can be used. The pseudo label 303 is generated by inputting the data set 301 to the classifier 302, acquiring a feature amount before being input to a fully connected layer, and then clustering the feature amount by the k-means method. As the inference result 304, an output after the feature amount is input to the fully connected layer is used. A loss between the pseudo label 303 and the inference result 304 is calculated, and a result thereof is subjected to error backpropagation, thereby training the classifier 302. By using the classifier generation method by self-supervised learning as in the present exemplary embodiment, it is not necessary to label a large amount of data sets, and thus it is possible to minimize a preparation load of training data.

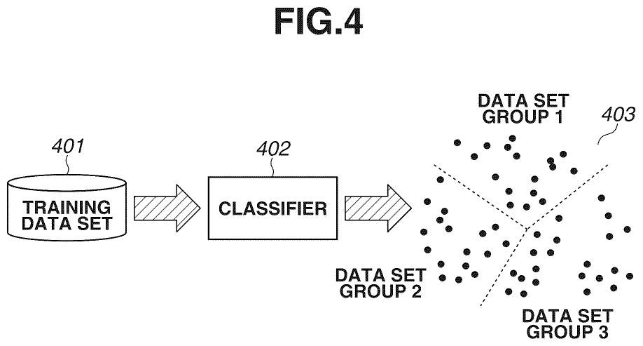

FIG. 4 is a diagram illustrating a classification method of a training data set 401. Although a feature space is originally a multidimensional feature space, a two-dimensional feature space will be described in order to simplify the description. In the present exemplary embodiment, the number of clusters is assumed to be three in order to simplify the description. Hereinafter, pieces of data belonging to clusters 1 to 3 are referred to as data set groups 1 to 3, respectively. When the training data set 401 is input to a classifier 402, a position of each piece of data on the feature space is identified, and the pieces of data are clustered into data set groups 1 to 3 as indicated by a classification result 403.

Next, in step S202, the training unit 140 trains the NN model by using the training data set 110.

Subsequently, in step S203, the difficult image determination unit 150 determines whether difficult image data is included, based on a difference between a result of training data inferred at the time of training in S202 and GT. As a method of calculating a difference between each inference result and GT, for example, a Loss function such as a mean square error or cross entropy may be used, or the difference may be calculated as a difference in pixel value between each inference result and GT. In a case where all the differences calculated in the inference results are less than a threshold value, the difficult image determination unit 150 determines that the difficult image data is not included in the inferred training data, and ends the processing without doing anything.

On the other hand, if there is data whose difference is the threshold value or more, the data is determined to be difficult image data. In this way, in a case where the difficult image determination unit 150 determines that difficult image data is included, the processing proceeds to step S204, and the processing in steps S204 to S206 and step S202 are repeatedly performed. Note that a range in which the difference between each inference result and GT is calculated may be the entire image or a local portion acquired by dividing the image. In addition, in the present exemplary embodiment, the difference from GT is calculated by using the inference result at the time of training, but the difference from GT may be calculated by using data different from data used at the time of training, for example, verification data.

In step S204, the processor 701 inputs difficult image data whose difference from GT is a threshold value or more, to the classifier 120 and performs clustering. Herein, a method of clustering difficult image data will be described.

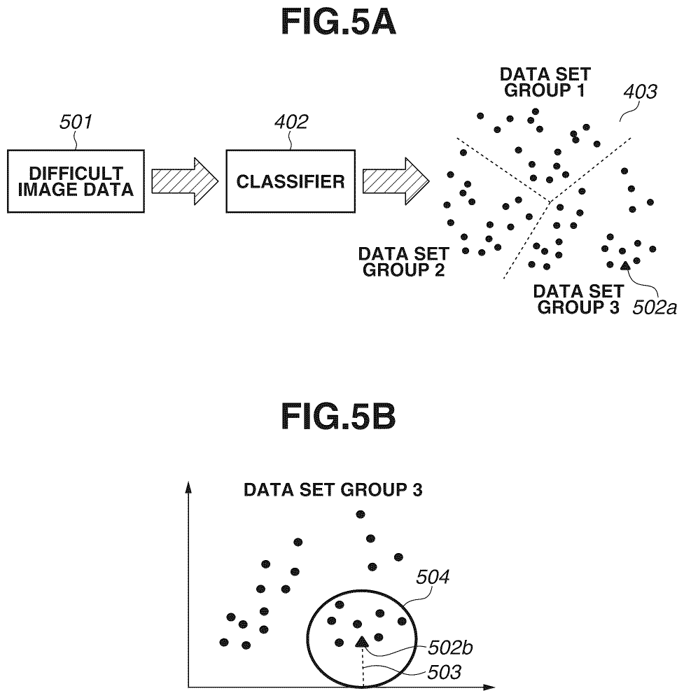

FIG. 5A is a diagram for describing a clustering method using a classifier. When the classifier 402 performs clustering by inputting difficult image data 501 whose difference from GT is a threshold value or more, the classifier 402 outputs a feature amount 502a of the difficult image data 501. Then, it is identified to which cluster of data set group the output feature amount 502a belongs with respect to a classification result 403 clustered in advance. In the present exemplary embodiment, it is assumed that the feature amount 502a of the difficult image data 501 belongs to the data set group 3.

In step S205, the similarity calculation unit 170 calculates the similarity between the difficult image data and each piece of data in the data set group belonging to the same cluster. The similarity may be acquired on a same feature space as when clustering is performed by a classifier, or may be calculated in an image feature amount space different from the classifier, for example, as a difference in pixel value or luminance value of images. Further, the feature amount of the image may be converted into a vector, and the similarity may be calculated by an inter-vector distance such as a cosine similarity or a Euclidean distance. In the present exemplary embodiment, the similarity is calculated by using cosine similarity as an example. The cosine similarity cos (x, y) is expressed by the following equation (1).

$$( 1 )$$

$$cos ( x , y ) = \frac{x \cdot y}{‖ x ‖ \cdot ‖ y ‖} = \frac{{x}_{1} {y}_{1} + {x}_{2} {y}_{2} + ⋯ + {x}_{n} {y}_{n}}{\sqrt{{\vert {x}_{1} \vert}^{2} + {\vert {x}_{2} \vert}^{2} + ⋯ + {\vert {x}_{n} \vert}^{2}} \sqrt{{\vert {y}_{1} \vert}^{2} + {\vert {y}_{2} \vert}^{2} + ⋯ + {\vert {y}_{n} \vert}^{2}}}$$

Herein, the feature amount of the difficult image data is an n-dimensional feature vector x=(x₁, x₂, . . . , and xₙ). On the other hand, the feature amount of data of the data set group belonging to the same cluster identified in step S204 is an n-dimensional feature vector y=(y₁, y₂, . . . , and yₙ). In the present exemplary embodiment, the cosine similarity is calculated by substituting the vector values of x and y into the equation (1).

In step S206, the data selection unit 180 selects data with a high similarity, based on the similarity calculated in step S205, and adds the data to the training data. Since the cosine similarity approaches one as the similarity between two feature vectors increases, data with a cosine similarity close to one is preferentially added to the training data. When the data is added to the training data, the data may be simply added to the training data set used for training, or a use frequency of only the selected data may be increased at the time of training. In the present exemplary embodiment, a method of selecting data to be added to the training data from the training data set 110 (the data set group 130) has been described. However, training data for adding may be separately prepared, and data may be selected therefrom.

FIG. 5B is a diagram illustrating an example of selecting data with a high similarity, based on the similarity calculated in step S205. In this exemplary embodiment, first, a similarity between a feature amount 502b of the difficult image data in the feature space of the image and data in the data set group 3 belonging to the same cluster is calculated. After that, data existing in a circle 504 with a radius of a predetermined threshold value 503 centered on the feature amount 502b of the difficult image data is regarded as having a similarity of a predetermined value or more, and the data existing in the circle 504 is selected and added to the training data. It is easier to select training data that is considered to be difficult image data when training is desired to be intensively performed with difficult image data. The inference result can be brought closer to the GT by intensively performing training using image data which is considered to be difficult image data.

By clustering the training data set in advance as in the present exemplary embodiment, it is possible to omit calculation of a similarity with data belonging to another cluster, and thus it is possible to reduce the time until data to be added to the training data is selected. In addition, by performing clustering in advance, for example, data cleansing such as preventing unintended data from being mixed into training data by identifying an erroneous cluster using the method described in Japanese Patent Application Laid-Open No. 2022-150552 is facilitated, and appropriate data can be selected as training data.

In the present exemplary embodiment, the noise reduction task has been described as an example. However, the present exemplary embodiment can also be applied to other image quality improvement tasks such as a super-resolution task. In addition, the present exemplary embodiment is not limited to the image quality improvement task, and can also be applied to, for example, a classification task or a bounding box (BB) detection task. In a case of the classification task, training data is selected in such a way as to improve a class whose accuracy is less than a predetermined threshold value. Further, in a case of the BB detection task, an average precision (AP) of each class is set, and training data is selected in such a way that the AP improves in a class whose AP is less than a predetermined threshold value. In addition, the present exemplary embodiment can be applied to any task having an evaluation index that can be represented by a numerical value.

Hereinafter, in a second exemplary embodiment, a flow of processing of selecting training data in a case of training an NN model will be described using a noise reduction task as an example. In the first exemplary embodiment, an example of generating a classifier for clustering a data set by self-supervised learning described in Mathilde Caron, Piotr Bojanowski, Armand Joulin, and Matthijs Douse: Deep Clustering for Unsupervised Learning of Visual Features has been described. On the other hand, in the present exemplary embodiment, an example in which a classifier is generated by supervised learning will be described. A configuration of the information processing apparatus according to the exemplary embodiment is similar to those in FIGS. 1 and 7, and a basic flow of a processing procedure is also similar to that in FIG. 2, and description thereof will be omitted. The present exemplary embodiment is different from the first exemplary embodiment in the method of generating a classifier to be used in step S201.

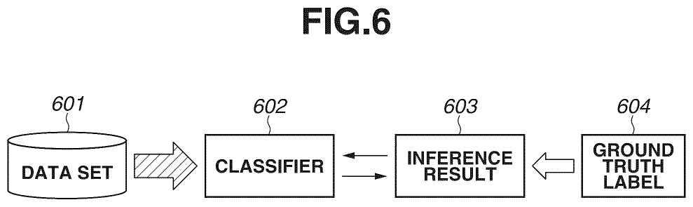

FIG. 6 is a diagram illustrating a method of generating a classifier using supervised learning according to the present exemplary embodiment. First, a data set 601 is input to a classifier 602, and an inference result 603 is output. Then, a loss between the output inference result 603 and supervised learning data 604 labeled with a ground truth label in advance is calculated, and the classifier 602 is trained by the error backpropagation method. As the supervised learning data 604, for example, data labeled for each evaluation index of the noise reduction task is used. Herein, as an evaluation index, in addition to the above-described PSNR, for example, a signal to noise ratio (SNR), a Structural SIMilarity (SSIM), or a mean squared error (MSE) may be used.

By using a method of the present exemplary embodiment, when an evaluation score is low in a specific evaluation index, data similar to data with a low evaluation score can be immediately identified, and training of the NN model can progress efficiently. In the present exemplary embodiment, the data labeled for each evaluation index has been used as the supervised learning data 604, but the present exemplary embodiment is not limited thereto. For example, a characteristic such as a secular change may be reflected in the training data by labeling for each time series, or a bias between hues in the training data may be eliminated by labeling for each image characteristic such as luminance, brightness, and saturation.

### Other Embodiments

In the above-described exemplary embodiment, the classifier has been generated by using self-supervised learning or supervised learning, but the method of generating a classifier is not limited thereto. For example, the classifier may be generated in such a way as to perform clustering according to the similarity of feature vectors of an image, by using unsupervised learning.

Further, in the method of generating a classifier, hierarchical clustering such as the Ward method may be used, or representative non-hierarchical clustering such as the k-means method may be used.

Furthermore, in the above-described exemplary embodiment, as illustrated in FIG. 5B, data whose distance is within a predetermined value centering on the feature amount of the difficult image data is selected and added to the training data, but data to be added to the training data may be selected by using a different method. For example, after a cluster to which the difficult image data belongs is identified by clustering the difficult image data, data whose distance from the centroid in the cluster is within a predetermined value may be added as training data. By using this method, the calculation of the similarity can be made unnecessary, and the training data can be selected at a higher speed.

The present disclosure can also be achieved by a process of supplying a program, which achieves one or more functions of the above-described exemplary embodiments, to a system or a device via a network or a storage medium, and one or more processors in a computer of the system or device reading and executing the program. Further, the present disclosure can also be achieved by a circuit (for example, application specific integrated circuit (ASIC)) that achieves one or more functions.

The disclosure of the exemplary embodiments includes the following configurations, methods, and programs.

According to the exemplary embodiments of the present disclosure, it is possible to improve the non-uniformity of training efficiency due to training data by efficiently selecting training data, and improve the accuracy of a neural network model.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-007266, filed Jan. 22, 2024, which is hereby incorporated by reference herein in its entirety.

What is claimed is:

1. An information processing apparatus comprising:
at least one processor or circuit configured to function as:
a classification unit configured to classify a training data set for training a neural network model into any one of a plurality of clusters by clustering the training data set;
a determination unit configured to determine image data in which a difference between a ground truth of the training data set and an inference result of training data by the neural network model or verification data different from data used at a time of training is a threshold value or more;
a calculation unit configured to identify a cluster to which the image data determined by the determination unit belongs, from among the plurality of clusters, and calculate a similarity between data classified into the identified cluster by the classification unit and the determined image data; and
a selection unit configured to select, as training data for additionally training the neural network model for an image quality improvement task, data from among data classified into the identified cluster where the similarity of the data calculated by the calculation unit is greater than or equal to a predetermined value.

2. The information processing apparatus according to claim 1, wherein the classification unit performs classification by using a classifier generated by supervised learning using supervised learning data labeled for each evaluation index, for each time series, or for each image characteristic.

3. The information processing apparatus according to claim 2, wherein the evaluation index is Signal to Noise Ratio (SNR), Peak Signal to Noise Ratio (PSNR), Structural SIMilarity (SSIM), or Mean Squared Error (MSE).

4. The information processing apparatus according to claim 2, wherein the image characteristic is luminance, brightness, or saturation.

5. The information processing apparatus according to claim 1, wherein the classification unit performs classification according to a similarity of feature vectors of an image, by using a classifier generated using unsupervised learning.

6. The information processing apparatus according to claim 1, wherein the classification unit performs classification by using a classifier generated using hierarchical clustering or non-hierarchical clustering.

7. The information processing apparatus according to claim 1, wherein the determination unit performs determination by dividing training data into local regions and calculating a difference from the ground truth for each local region.

8. The information processing apparatus according to claim 1, wherein the calculation unit identifies a cluster to which the determined image data belongs, from among the plurality of clusters, by using a same classifier as a classifier used by the classification unit.

9. The information processing apparatus according to claim 1, wherein the calculation unit calculates the similarity by using a feature amount of an image.

10. The information processing apparatus according to claim 9, wherein the calculation unit converts a feature amount of the image into a vector, and calculates the similarity, based on a distance between vectors.

11. The information processing apparatus according to claim 1, wherein the calculation unit calculates a similarity, based on a difference between a pixel value or a luminance value of an image.

12. An information processing apparatus comprising:
at least one processor or circuit configured to function as:
a classification unit configured to cluster a training data set for training a neural network model and classify the training data set into one of a plurality of clusters;
a determination unit configured to determine image data in which a difference between a ground truth of the training data set and an inference result of training data by the neural network model or verification data different from data used at a time of training is a threshold value or more;
an identification unit configured to identify a cluster to which the image data determined by the determination unit belongs, from among the plurality of clusters; and
a selection unit configured to select, as training data for training the neural network model, data whose distance from a centroid in the identified cluster is within a predetermined value, from among data classified by the classification unit into the cluster identified by the identification unit.

13. A method of controlling an information processing apparatus comprising:
clustering a training data set for training a neural network model, thereby classifying the training data set into one of a plurality of clusters;
determining image data in which a difference between a ground truth of the training data set and an inference result of training data by the neural network model or verification data different from data used at a time of training is a threshold value or more;
identifying a cluster to which the image data determined in the determination belongs, from among the plurality of clusters, and calculating a similarity between data classified into the identified cluster in the classification and the determined image data; and
selecting, as training data for additionally training the neural network model for an image quality improvement task, data from among data classified into the identified cluster where the similarity of the data calculated in the calculation is greater than or equal to predetermined value.

14. A method of controlling an information processing apparatus comprising:
clustering a training data set for training a neural network model, thereby classifying the training data set into one of a plurality of clusters;
determining image data in which a difference between a ground truth of the training data set and an inference result of training data by the neural network model or verification data different from data used at a time of training is a threshold value or more;
identifying a cluster to which the image data determined in the determination belongs, from among the plurality of clusters; and
selecting, as training data for training the neural network model, data whose distance from a centroid in the identified cluster is within a predetermined value, from among data classified in the classification into the cluster identified in the identification.

15. A non-transitory computer-readable storage medium storing a computer-executable program comprising instructions for executing following operations:
clustering a training data set for training a neural network model, thereby classifying the training data set into one of a plurality of clusters;
determining image data in which a difference between a ground truth of the training data set and an inference result of training data by the neural network model or verification data different from data used at a time of training is a threshold value or more;
identifying a cluster to which the image data determined in the determination belongs, from among the plurality of clusters, and calculating a similarity between data classified into the identified cluster in the classification and the determined image data; and
selecting, as training data for additionally training the neural network model for an image quality improvement task, data from among data classified into the identified cluster where the similarity of the data calculated in the calculation is greater than or equal to predetermined value.

16. A non-transitory computer-readable storage medium storing a computer-executable program comprising instructions for executing following operations:
clustering a training data set for training a neural network model, thereby classifying the training data set into one of a plurality of clusters;
determining image data in which a difference between a ground truth of the training data set and an inference result of training data by the neural network model or verification data different from data used at a time of training is a threshold value or more;
identifying a cluster to which the image data determined in the determination belongs, from among the plurality of clusters; and
selecting, as training data for training the neural network model, data whose distance from a centroid in the identified cluster is within a predetermined value, from among data classified in the classification into the cluster identified in the identification.
